(19) United States
(12) Patent Application Publication
(10) Pub. No.: US 2026/0276071 A1
(43) Pub. Date: Sep. 17, 2026

(54) LUBRICATING AND/OR COOLING SYSTEM FOR USE IN A MOTOR VEHICLE

(71) Applicant: MAGNA Powertrain GmbH & Co KG, Lannach (AT)

(72) Inventor: Christoph GSENGER, Graz (AT)

(21) Appl. No.: 19/369,512

(22) Filed: Oct. 27, 2025

(30) Foreign Application Priority Data
Nov. 4, 2024 (DE) 10 2024 132 036.2

(51) Int. Cl. F16H 57/04

(52) U.S. Cl. CPC F16H 57/0404; F16H 57/0436; F16H 57/045

(57) ABSTRACT

A lubricating and/or cooling system for use in a motor vehicle, comprising a first oil container with oil and a pump unit for conveying the oil from the first oil container, and a first separating device is arranged in the first oil container. The first separating device is arranged in the first oil container with an inclination to the direction of flow of the oil, namely in a direction of inclination in the direction of an oil intake point of the pump unit, including an angle of inclination with respect to the direction of flow of the oil.

### CROSS-REFERENCE TO RELATED APPLICATIONS

This application claims priority to German Application No. DE 10 2024 132 036.2 filed on Nov. 4, 2024. The entire disclosure of the above application is incorporated herein by reference.

### FIELD OF THE INVENTION

The present invention relates to a lubricating and/or cooling system for use in a motor vehicle comprising a first oil container with oil and a pump unit for conveying the oil from the first oil container, wherein a first separating device is arranged in the first oil container.

### BACKGROUND OF THE INVENTION

Lubricating and/or cooling systems with oil play a central role in the field of automotive engineering. Foaming typically occurs when rotating (transmission) components come into contact with the oil. This increases the proportion of air in the oil, which negatively impacts the capacity of the oil to dissipate heat from temperature-critical active components, such as active components in a transmission, since a high proportion of air in the oil results in a lower specific heat capacity of the oil volume flow in comparison with the pure oil phase. This leads to a deterioration in heat transfer into the oil, thus significantly reducing the cooling performance of the oil. Furthermore, an oil/air mixture has a lower density than a pure oil phase. Therefore, the conveyed volume flow of a feed pump for conveying the oil would have to be increased to achieve the same mass flow as with the pure oil phase. Furthermore, the pump has a lower efficiency when conveying the oil/air mixture.

### SUMMARY OF THE INVENTION

One object of the invention is to indicate an improved lubricating and/or cooling system for use in a motor vehicle.

This need can be met by the subject matter of the present invention according to independent Claim 1. Advantageous embodiments of the present invention are described in the dependent claims.

The lubricating and/or cooling system according to the invention is used in particular in a motor vehicle. However, application in other technical fields outside of automotive engineering is not excluded.

According to the present invention, the lubricating and/or cooling system comprises a first oil container with oil and a pump unit for conveying the oil from the first oil container.

According to the invention, a first separating device is arranged in the first oil container, wherein the first separating device is arranged in the first oil container with an inclination to the direction of flow of the oil, namely in a direction of inclination in the direction of an oil intake point of the pump unit, including an angle of inclination with respect to the direction of flow of the oil.

The angle of inclination with respect to the direction of flow of the oil is preferably less than or equal to 60°, in particular less than or equal to 30°.

The first separating device preferably has at least one screen and/or at least one filter.

The first separating device can furthermore be arranged directly in the first oil container or indirectly in the first oil container, installed in a separate structural unit.

In one advantageous embodiment variant, the lubricating and/or cooling system has a second oil container, wherein the second oil container is arranged in relation to the first oil container at a level above it and wherein oil can be conveyed from the first oil container into the second oil container via the pump unit via at least one mechanical component.

A second separating device is preferably arranged in the second oil container, wherein the second separating device is arranged horizontally above all oil outlets of the second oil container.

The second separating device has at least one screen and/or a filter and can be arranged directly in the second oil container or indirectly in the second oil container, installed in a separate structural unit.

In particular, the “oblique” arrangement or arrangement inclined by an angle of inclination according to the invention of the first separating device in the first oil container allows the air bubbles within the oil to be pushed “upwards”. This significantly reduces the air content in the oil, allowing in particular more heat to be dissipated from the components cooled with the oil.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 shows a sectional representation of a transmission for a motor vehicle with a lubricating and/or cooling system.

FIG. 2 shows an embodiment variant of a separate structural unit with a first separating device.

### DESCRIPTION OF THE INVENTION

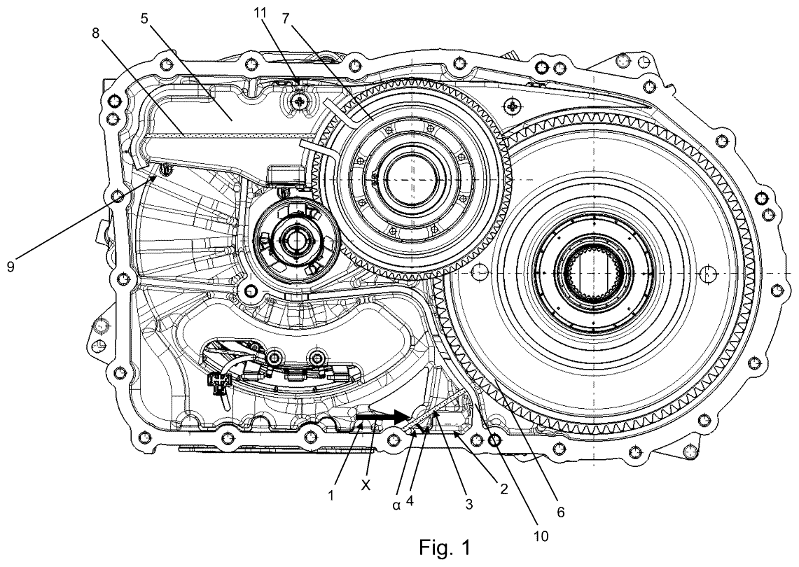

In FIG. 1, a sectional representation of a transmission for a motor vehicle is represented schematically, wherein the lubricating and/or cooling system according to the invention is an integral component of the represented transmission.

The lubricating and/or cooling system has a first oil container 1, a second oil container 5 and a pump unit 2.

The second oil container 5 is arranged in relation to a spatial arrangement of the first oil container 1 at a level above it and thus forms a “high container”.

There is oil up to a maximum fill level at least in the first oil container 1.

The pump unit 2 is used to convey the oil from the first oil container 1 via several mechanical components 6, 7 into the second oil container 5. From the second oil container 5, the oil can flow back into the first oil container 1 via several oil outlets 9 of the second oil container 5.

A first separating device 3 is arranged in the first oil container 1 and a second separating device 8 is arranged in the second oil container 5.

The first separating device 3 and the second separating device 8 are each designed to have a large surface area and are arranged directly in the respective oil container 1, 5.

In the present case, the first separating device 3 and the second separating device 8 are formed from a metal screen with a mesh size of approximately 0.25 millimetres. However, filters of any type or plastic screens can also be used.

In FIG. 1, the first separating device 3, i.e. the respective metal screen, is arranged in a fixed manner directly on a housing 10 that at least partially forms the first oil container 1. The second separating device 8, i.e. the respective metal screen, is arranged directly in the second oil container 5 horizontally above all oil outlets 9 in the second oil container 5, in terms of a spatial arrangement below an oil inlet 11 of the second oil container 5.

The first separating device 3 is arranged in the first oil container 1 with an inclination to the direction of flow X of the oil, namely in a direction of inclination in the direction of an oil intake point 4 of the pump unit 2, including an angle of inclination a with respect to the direction of flow X of the oil.

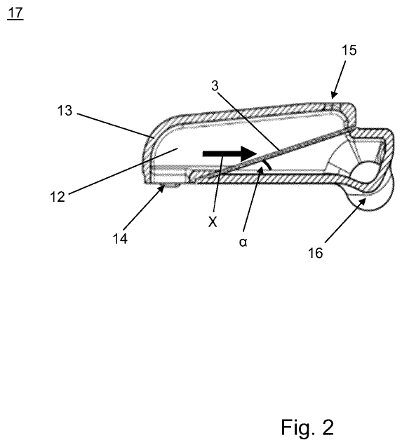

FIG. 2 shows an alternative embodiment variant of the first separating device 3 to the embodiment variant of the first separating device 3 shown in FIG. 1. In this case, the first separating device is also designed as a metal screen, but is installed in a separate structural unit 17. The separate structural unit 17 has a separating device housing 13 enclosing a cavity 12 with at least one oil inlet 14, a gas outlet 15, and a pump connection means 16, wherein the first separating device 3 is arranged in the cavity 12 fixedly on the separating device housing 13.

The separate structural unit 17 can be installed, for example, as an alternative to the direct installation of the first separating device 3 in a transmission, as shown, for example, in FIG. 1.

A fluid connection between the first oil container 1 and the cavity 12 of the separating device housing 13 can be realized via the oil inlet 14 of the separating device housing 13.

For example, air can escape from the cavity 12 of the separating device housing 13 via the gas outlet 15.

The pump connection means 16 serves for the direct or indirect connection of the cavity 12 of the separating device housing 13 to the oil intake point 4 of the pump unit 2.

The first separating device 3 is arranged in the cavity 12 of the separating device housing 13 in a fixed manner on the separating device housing 13 in the direction of flow X of the oil between the oil inlet 11 and the pump connection means 16. The first separating device 3 is arranged at an inclination relative to the direction of flow X of the oil, namely in a direction of inclination in the direction of the pump connection means 16 of the pump unit 2 and thus in the direction of the oil intake point 4 of the pump unit, including an angle of inclination a with respect to the direction of flow X of the oil.

What is claimed is:

1. A lubricating and/or cooling system for use in a motor vehicle, comprising a first oil container with oil and a pump unit for conveying the oil from the first oil container, wherein a first separating device is arranged in the first oil container, and wherein the first separating device is arranged in the first oil container with an inclination to the direction of flow of the oil, namely in a direction of inclination in the direction of an oil intake point of the pump unit, including an angle of inclination with respect to the direction of flow of the oil.

2. The lubricating and/or cooling system according to claim 1, wherein the angle of inclination with respect to the direction of flow of the oil is≤60°.

3. The lubricating and/or cooling system according to claim 1, wherein the first separating device has at least one screen and/or at least one filter.

4. The lubricating and/or cooling system according to claim 1, wherein the first separating device is arranged directly in the first oil container or indirectly in a separate structural unit installed in the first oil container.

5. The lubricating and/or cooling system according to claim 1, wherein the lubricating and/or cooling system has a second oil container, wherein the second oil container is arranged in relation to the first oil container at a level above it, and wherein oil can be conveyed from the first oil container into the second oil container via the pump unit via at least one mechanical component.

6. The lubricating and/or cooling system according to claim 5, wherein a second separating device is arranged in the second oil container, and wherein the second separating device is arranged horizontally above all oil outlets of the second oil container.

7. The lubricating and/or cooling system according to claim 6, wherein the second separating device has at least one screen and/or at least one filter.

8. The lubricating and/or cooling system according to claim 6, wherein the second separating device is arranged directly in the second oil container or indirectly in the second oil container, installed in a separate structural unit.
